(19) United States
(12) Patent Application Publication
(10) Pub. No.: US 2024/0325878 A1
(43) Pub. Date: Oct. 3, 2024

(54) SYSTEMS AND METHODS FOR GENERATING ADAPTIVE CONTROL LAYOUTS FOR SECOND SCREEN DEVICES

(71) Applicant: Netflix, Inc., Los Gatos, CA (US)

(72) Inventors: Olivier Jean Poitrey, Le Chesnay (FR); James Smith, Los Gatos, CA (US); Chase Rubin Meusel, Woodbury, MN (US)

(21) Appl. No.: 18/193,615

(22) Filed: Mar. 30, 2023

(51) Int. Cl. A63F 13/22; A63F 13/21; A63F 13/50; A63F 13/92

(52) U.S. Cl. CPC A63F 13/22; A63F 13/21; A63F 13/50; A63F 13/92

(57) ABSTRACT

The disclosed computer-implemented methods and systems include generating an adaptive control layout in connection with a video game and for a second screen device while the video game is being played via a physically separate first screen device. For example, the disclosed methods and systems can determine that a trigger event has occurred relative to the video game based on control inputs from video game controls displayed on the second screen device. The disclosed systems and methods can generate a new control layout that is tailored to the trigger event. The disclosed systems and methods can automatically replace the first control layout with the second control layout on the second screen device without interrupting video game play. Various other methods, systems, and computer-readable media are also disclosed.

### BACKGROUND

Video games continue to be a popular and pervasive form of entertainment. Video gaming platforms constantly try to create video games that are faster, more exciting, and more immersive. Typically, a video game is played on a game console or computer that displays game graphics via a display device such as a TV or monitor, while a player interacts with the displayed game via a physical controller or other input device. Video game controllers generally include a collection of physical buttons, joysticks, track pads, paddles, and so forth. As such, typical video game controllers are rigidly tied to a single control layout of dedicated buttons, joysticks, etc. In light of this, video game creators are similarly tied to the limitations of the video game controller.

In some instances, such as with mobile gaming, a video game may include buttons and other controls that are displayed on a touch screen. This layout of buttons and controls, however, is positioned on top of the game graphics within the same mobile display. As such, the game controls may block game graphics and/or otherwise limit the useability and immersiveness of the video game as it is played on a mobile device with a smaller display screen.

### SUMMARY

As will be described in greater detail below, the present disclosure describes implementations that generate adaptive control layouts for second screen devices (e.g., such as smartphones used as video game controllers to control video games displayed on a primary screen, such as a TV) during video game play. In one example, a computer-implemented method can include, in response to a detected selection of a video game via a first screen device, converting a second screen device to a game controller with a first control layout, receiving, from the second screen device and via the first control layout, one or more control inputs associated with the video game displayed on the first screen device, detecting a trigger event associated with the video game that necessitates a second control layout for the second screen device, and causing the second screen device to replace the first control layout with the second control layout. For example, in one or more implementations, the first screen device is physically separate from the second screen device.

In one or more implementations, receiving, from the second screen device and via the first control layout, the one or more control inputs associated with the video game displayed on the first screen device can include receiving one or more of tap touch gesture inputs, press-and-hold touch gesture inputs, press-and-slide touch gesture inputs, multi-finger touch gesture inputs, variable pressure touch gesture inputs, sound inputs, or gyroscopic inputs.

Additionally, in some implementations, detecting the trigger event associated with the video game that necessitates the second control layout for the second screen device can include determining the type of trigger event and determining that the type of trigger event necessitates a control layout that is different from the first control layout. For example, detecting the trigger event associated with the video game that necessitates the second control layout for the second screen device can include detecting at least one of a predetermined point in the video game, a predetermined level in the video game, a predetermined character in the video game, a predetermined object in the video game, a preference request associated with a user of the second screen device, or an accessibility selection received via the first control layout. Moreover, in some implementations, detecting the trigger event associated with the video game that necessitates the second control layout for the second screen device can include detecting an interaction with a specific video game control within the first control layout.

In some implementations, the method can further include, in response to detecting the trigger event, generating the second control layout for the second screen device based on the trigger event. For example, generating the second control layout for the second screen device based on the trigger event can include determining, based on the video game, one or more video game controls correlated with the trigger event and assembling the one or more video game controls into the second control layout.

In at least one implementation, causing the second screen device to replace the first control layout with the second control layout can include generating display instructions including instructions for removing the first control layout from the second screen device and instruction for displaying the one or more video game controls in the second control layout and providing the display instructions to the second screen device.

In some implementations, the method can further include receiving, during ongoing game play of the video game and via the second control layout on the second screen device, additional control inputs associated with the video game displayed on the first screen device, detecting an additional trigger event associated with the video game that necessitates the first control layout for the second screen device and causing the second screen device to replace the second control layout with the first control layout

Some examples described herein include a system with at least one physical processor and physical memory including computer-executable instructions that, when executed by the at least one physical processor, cause the at least one physical processor to perform various acts. In at least one example, the computer-executable instructions, when executed by the at least one physical processor, cause the at least one physical processor to perform acts including, in response to a detected selection of a video game via a first screen device, converting a second screen device to a game controller with a first control layout, receiving, from the second screen device and via the first control layout, one or more control inputs associated with the video game displayed on the first screen device, detecting a trigger event associated with the video game that necessitates a second control layout for the second screen device, and causing the second screen device to replace the first control layout with the second control layout.

In some examples, the above-described method is encoded as computer-readable instructions on a computer-readable medium. In one example, the computer-readable instructions, when executed by at least one processor of a computing device, cause the computing device to, in response to a detected selection of a video game via a first screen device, convert a second screen device to a game controller with a first control layout, receive, from the second screen device and via the first control layout, one or more control inputs associated with the video game displayed on the first screen device, detect a trigger event associated with the video game that necessitates a second control layout for the second screen device, and cause the second screen device to replace the first control layout with the second control layout.

In one or more examples, features from any of the embodiments described herein are used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an exemplary environment for implementing a control layout system in accordance with one or more implementations.

FIG. 2 is a flow diagram of an exemplary computer-implemented method for generating a second control layout to replace a first control layout on a second screen device in accordance with one or more implementations.

FIG. 3 illustrates a sequence diagram of steps taken by the control layout system while detecting trigger events and generating adaptive control layouts in accordance with one or more implementations.

FIGS. 4A-4B illustrate adaptive control layouts generated for display on a second screen device in accordance with one or more implementations.

FIG. 4C illustrates a layout of controls that include semantic symbols in accordance with one or more implementations.

FIG. 5 is a detailed diagram of the control layout system in accordance with one or more implementations.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

As mentioned above, a video game platform is typically limited to the layout and functionality of the physical video game controller that is specific to that video game platform. As such, video games designed for that video game platform must tailor game play to that physical controller. This, in turn, means that use of the physical controller while playing a particular video game may be non-intuitive or may even leave various buttons and other controls on the physical controller with no functionality at all. The mobile gaming space (i.e., where physical controllers may not be used) is also problematic because the digital controls for a video game are generally displayed on the same screen as the video game graphics. This can lead to a reduction in viewable display area for the video game and smaller controller sizes (e.g., for buttons, joysticks, etc.). As such, mobile games are often less immersive and harder to play.

In light of these problems, the present disclosure describes a system that generates customized and adaptive control layouts of buttons, joysticks, etc. for use on a second screen device such as a smartphone during video game play. For example, the described system can convert a player's smartphone into a video game controller for a video game being displayed on a first screen device such as a TV. The described system can also detect trigger events during game play that necessitate a change to the layout of buttons, joysticks, etc. on the smartphone. For example, the described system can generate a new control layout that provides the player with access to control functionality that is tailored to specific video game events (e.g., when encountering a particular level or point in a story, character, item, etc.) in real time. The customized and adaptive control layouts generated by the described system enhance game play by being presented on a second screen device that is separate from display of the game graphics such that game play is not limited or interrupted by the displayed controls. By doing so, the present disclosure can enable video game developers to create immersive, interactive, and dynamically adaptive video game experiences and control schemes that enhance the experience of end users while keeping the video game controller as concise and game specific as possible. As such, the present disclosure can lead to video game controllers that are more approachable for players, with larger hit zones for the various controls within each layout such that players can use the video game controllers more quickly and accurately.

Features from any of the implementations described herein may be used in combination with one another in accordance with the general principles described herein. These and other implementations, features, and advantages will be more fully understood upon reading the following detailed description in conjunction with the accompanying drawings and claims.

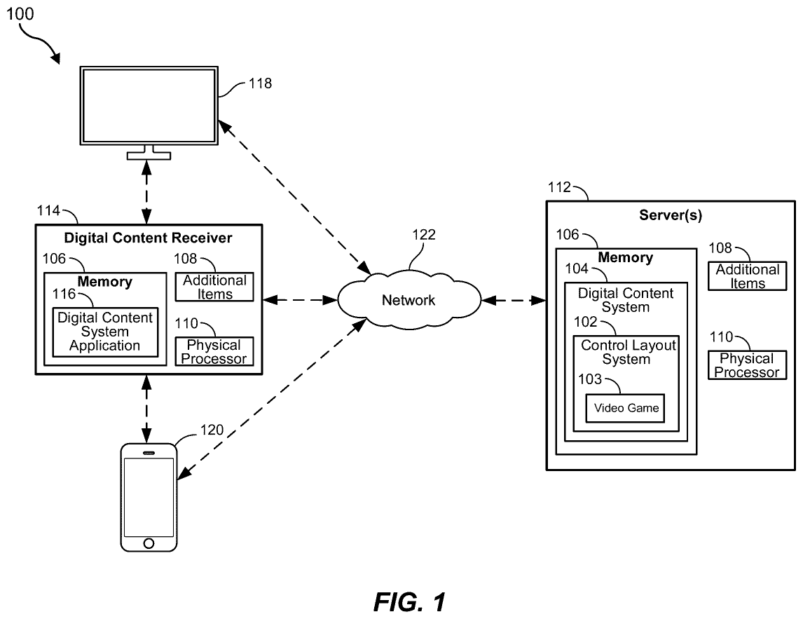

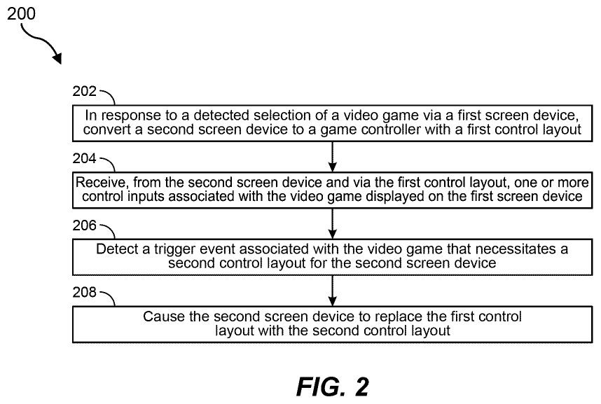

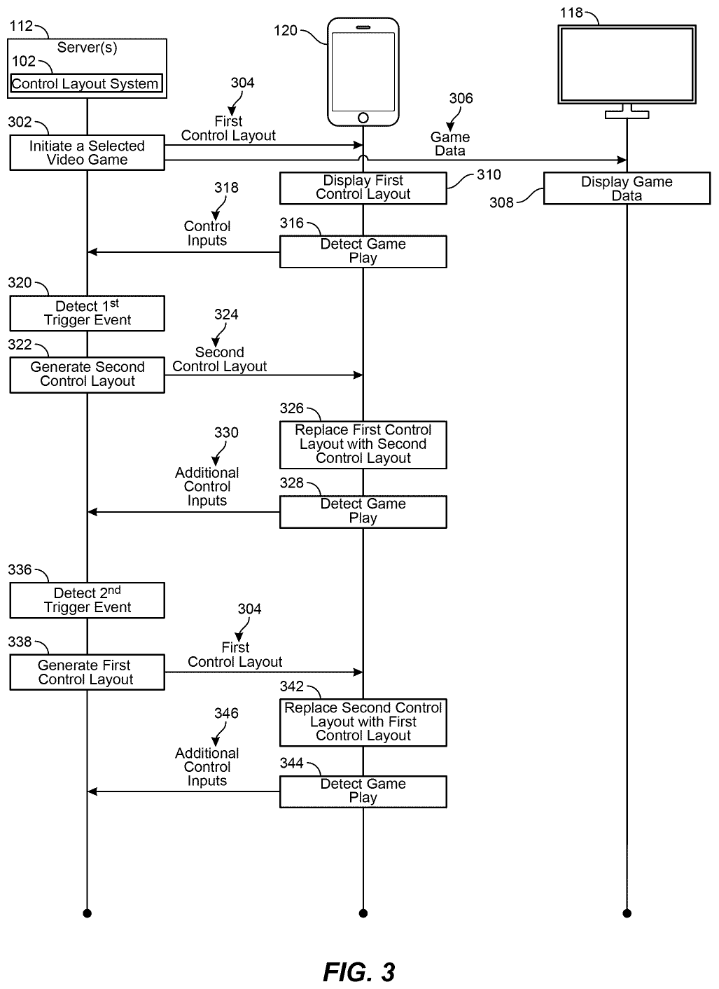

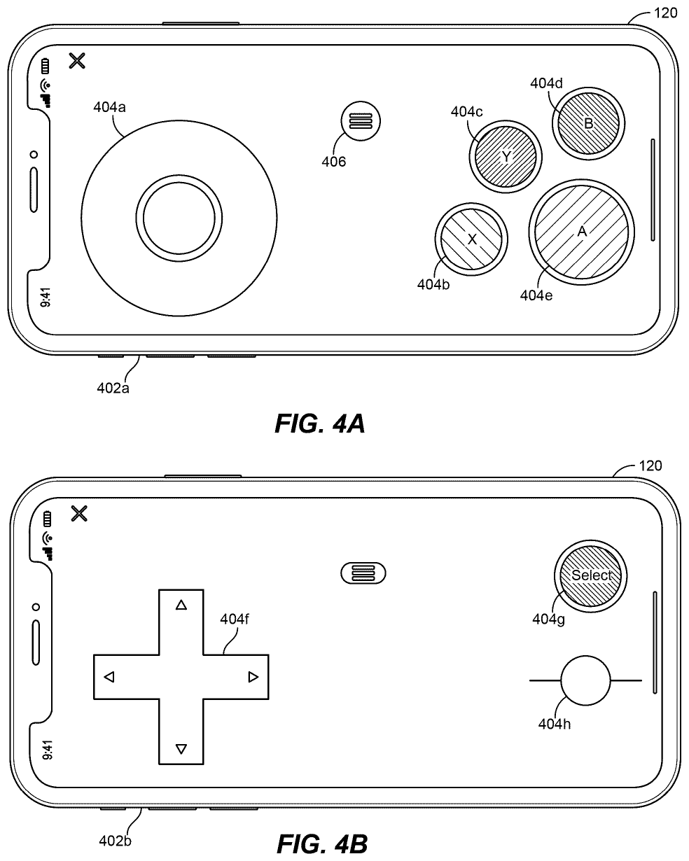

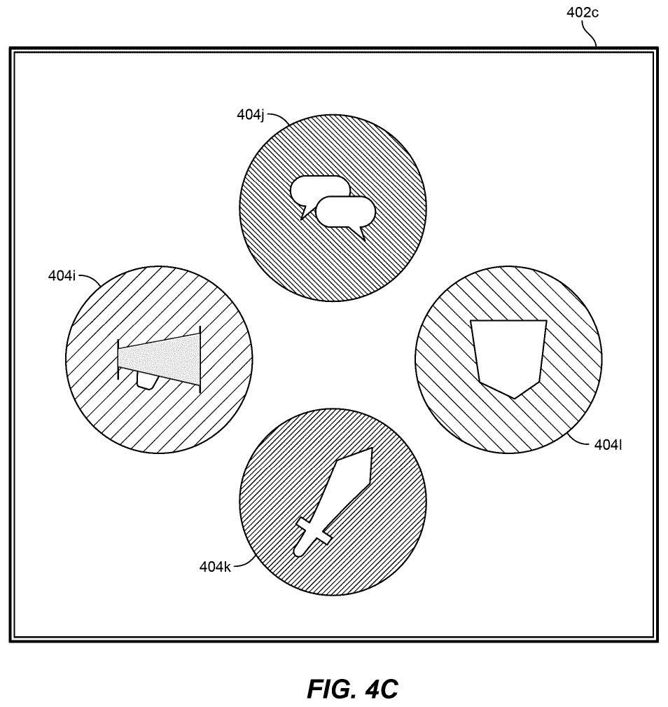

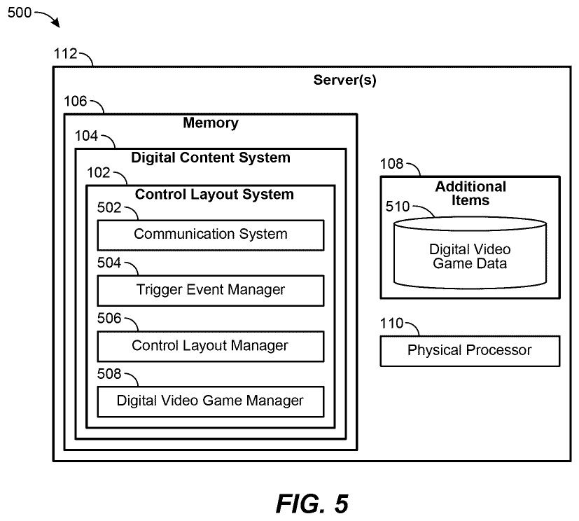

The following will provide, with reference to FIGS. 1-5, detailed descriptions of a control layout system that generates adaptive control layouts during video game play in response to detected trigger events within the video game. For example, an exemplary network environment is illustrated in FIG. 1 to show the control layout system operating in connection with a first screen device and a second screen device. FIG. 2 illustrates steps taken by the control layout system to generate adaptive control layouts for display on the second screen device during game play. FIG. 3 illustrates a sequence of steps taken by the control layout system during game play in order to generate and provide adaptive control layouts. FIGS. 4A-4C illustrate example control layouts generated by the control layout system in response to detected trigger events. Finally, FIG. 5 provides additional detail with regard to the features and functionality of the control layout system.

As just mentioned, FIG. 1 illustrates an exemplary networking environment 100 implementing aspects of the present disclosure. For example, the networking environment 100 can include server(s) 112, a digital content receiver 114, a first screen device 118, a second screen device 120, and a network 122. As further shown, the server(s) 112 and the digital content receiver 114 can include a memory 106, additional items 108, and a physical processor 110.

In one or more implementations, as shown in FIG. 1, the first screen device 118 may be a television and the second screen device 120 may be a smartphone. In some examples, the entire display of the second screen device 120 may serve as a controller for a video game 103 displayed on the first screen device 118. As further shown, the digital content receiver 114 may be a device that is separate from the first screen device 118 and the second screen device 120, and the first screen device 118 may be physically separate from the second screen device 120. In this implementation, the digital content receiver 114, the first screen device 118, and the second screen device 120 may be on the same subnet (e.g., within the same residence or location), or may be on different subnets. In additional implementations, the digital content receiver 114 and/or the functionality of the digital content receiver 114 may be incorporated into the first screen device 118 and/or the second screen device 120. In yet additional implementations, the first screen device 118 may be a digital projector, monitor, or other display device. Similarly, the second screen device 120 may be a tablet computer or a smart wearable device with an interactive display screen.

As further shown in FIG. 1, a control layout system 102 may be implemented as part of a digital content system 104 within the memory 106 on the server(s) 112. In one or more implementations, the digital content system 104 may include a subscription streaming service for providing digital media content subscribers. Additionally, the control layout system 102 may access the video game 103, run the video game 103, stream output from the video game 103 to one or both of the first screen device 118 and the second screen device 120 (e.g., to cause the first screen device 118 to render game graphics, to cause the second screen device 120 to display control layouts), receive control inputs from a video game controller (e.g., such as the second screen device 120), etc. In one or more implementations, the control layout system 102 works in concert with the video game 103 to analyze control inputs, change game states, detect trigger events associated with control layouts, and generate updated control layouts for display and use on the second screen device 120.

As further shown in FIG. 1, the digital content receiver 114 may include a digital content system application 116 within the memory 106 thereon. In some implementations, the digital content system application 116 may communicate information to and from the digital content system 104 via the network 122. In at least one implementation, the control layout system 102—in concert with the video game 103—may access and utilize data received by the digital content system 104 in generating and providing adaptive control layouts during video game play. In some implementations, the digital content system application 116 may be additionally installed on the first screen device 118 and/or the second screen device 120. For example, in one implementation, the first screen device 118 may receive video game display information via the digital content receiver 114 and the second screen device 120 may communicate directly with the server(s) 112 via an additional instance of the digital content system application 116 installed thereon. For example, the digital content system application 116 may be embedded on the second screen device 120 such that the second screen device 120 may communicate directly with the digital content system 104 and/or the control layout system 102.

As mentioned above, the digital content receiver 114 (and in some implementations the first screen device 118 and/or the second screen device 120) may be communicatively coupled with the server(s) 112 through the network 122. In one or more implementations, the network 122 may represent any type or form of communication network, such as the Internet, and may include one or more physical connections, such as a LAN, and/or wireless connections, such as a WAN. In some implementations, the network 122 may represent a telecommunications carrier network. In at least one implementation, the network 122 may represent combinations of networks such that the digital content receiver 114 and the first screen device 118 may communicate with the control layout system 102 via a wireless network while the second screen device 120 may communicate with the control layout system 102 via a cellular network.

Although FIG. 1 illustrates components of the exemplary networking environment 100 in one arrangement, other arrangements are possible. For example, in one implementation, the control layout system 102 can operate as a native application that may be installed on the digital content receiver 114. In another implementation, the control layout system 102 may operate across multiple servers. Moreover, in some implementations, the exemplary networking environment 100 may include multiple second screen devices 120—such as when a multiplayer game is being played on the first screen device 118. Similarly, the exemplary networking environment 100 may also include multiple first screen devices 118 such as when multiple players are playing a video game on separate displays. For example, in that implementation, the control layout system 102 can support the same video game being played by multiple players (e.g., on multiple second screen devices and multiple first screen devices) across multiple locations and on different user accounts within the digital content system 104.

In one or more implementations, and as will be explained in greater detail below, the methods and steps performed by the control layout system 102 reference multiple terms. For example, a “digital video game” can refer to a digital program that causes game graphics to be rendered on a display device, such as a first screen device as user inputs received via a second screen device manipulate or interact with the rendered game graphics. A video game may include points, places, junctures, levels, characters, and other displayed objects.

As used herein, a “preference request” can include a user setting configured relative to a video game. For example, a preference request can include a request for text to be displayed at a particular size, sounds to be played at a particular volume, colors to be displayed within a particular spectrum, and so forth. As used herein, an “accessibility selection” can refer to additional settings configured relative to a video that are specific to how a player can play the video game. For example, an accessibility selection may include preferences for left-handedness or right-handedness, language preferences, and so forth.

As used herein, a “control layout” can refer to a specific arrangement of video game controls. For example, a second screen device can display a control layout that includes one or more video game controls that are a predetermined size and positioned in a predetermined location within the layout. Video game controls can refer to an interactive graphic within a control layout that may be interacted with in specific ways and that is mapped to particular functions relative to the video game.

As such, “control inputs” can refer to data representing how a particular video game control is interacted with during game play. For example, a control input can indicate that a button control was pressed and held for five seconds during game play. “Touch gestures” can refer to types of interactions that may be detected in connection with video game controls. For example, a touch gesture can be a tap touch gesture, a press-and-hold touch gesture, a press-and-slide touch gesture, a multi-finger touch gesture, and/or a variable pressure touch gesture. Control inputs can further include sound inputs recorded or streamed via a microphone of the second screen device. Additionally, gyroscopic inputs can include changes detected in connection with a gyroscope of the second screen device that indicate that the second screen device is being tilted, rotated, tipped, etc.

As used herein, a “trigger event” can refer to an event relative to a video game that necessitates a change in a control layout on a device that serves as a controller for the video game. In some examples, trigger events can be categorized by a specific “type” that indicates the particular change that has occurred. To illustrate, a trigger event can refer to an encounter that has occurred within the video game. A trigger event can also refer to a special character that has been encountered within the video game. As such, certain types of encounters (e.g., an encounter with a new landscape) may not necessitate a control layout change, while other types of encounters—such as encountering a special character or item that can only be interacted with via certain video game controls—may necessitate a control layout change. In some instances, a trigger event may be based on an event specific to the video game, as described above. In additional instances, a trigger event may be detected in response to a specific interaction received via the control layout on the second screen device 120. For example, the control layout on the second screen device 120 may include one or more video game controls that, when interacted with, can cause a trigger event that leads to a change in control layout. To illustrate, a control layout may include a particular video game control depicting a handheld radio. In response to a detected selection of that video game control the control layout system 102 may update the control layout on the second screen device 120 to include video game control that mimic the look and operation of a handheld radio.

As mentioned above, FIG. 2 is a flow diagram of an exemplary computer-implemented method 200 for replacing a first control layout on the second screen device 120 with a second control layout generated in response to a detected trigger event during video game play. The steps shown in FIG. 2 may be performed by any suitable computer-executable code and/or computing system, including the system(s) illustrated in FIG. 5. In one example, each of the steps shown in FIG. 2 may represent an algorithm whose structure includes and/or is represented by multiple sub-steps, examples of which will be provided in greater detail below.

As illustrated in FIG. 2, at step 202 the control layout system 102 can, in response to a detected selection of a video game via a first screen device (e.g., the first screen device 118), convert a second screen device (e.g., the second screen device 120) to a game controller with a first control layout. For example, the digital content system 104—via the digital content system application 116—may provide access to a collection of digital video games. In at least one implementation, the digital content system application 116 can detect a selection of a particular digital video game title via the first screen device 118. In response to initiating game play, the control layout system 102 can convert the second screen device 120 to a game controller associated with the selected digital video game. Thus, the control layout system 102 may cause game graphics to be displayed on the first screen device 118 while causing the second screen device 120 to display the first control layout including one or more video game controls associated with the digital video game.

As further illustrated in FIG. 2, at step 204 the control layout system 102 can receive, from the second screen device and via the first control layout, one or more control inputs associated with the video game displayed on the first screen device. For example, the control layout system 102 can receive control inputs indicating that a button control has been tapped, that a joystick control has been slid and held in an extended position, etc. The control layout system 102 can also receive control inputs that are specific to the second screen device 120. For example, the control layout system 102 can receive control inputs indicating that the second screen device 120 has been tilted/inverted, control inputs including sounds captured by a microphone of the second screen device 120, and so forth.

At step 206 the control layout system 102 can detect a trigger event associated with the video game that necessitates a second control layout for the second screen device. For example, the control layout system 102 can determine a point, chapter, junction, etc. at which current game play has arrived within the digital video game. Based on this determination (and/or the one or more control inputs received at that point), the control layout system 102 can determine that a trigger event has occurred. To illustrate, the control layout system 102 can determine that game play is moving to a new level or new activity, that a specific character, item, quest, etc. has been encountered within the digital video game, or that a preference request has been received from the player. In response to detecting the trigger event, the control layout system 102 can generate and provide a second control layout for display and use on the second screen device 120.

Additionally, as illustrated in FIG. 2, at step 208 the control layout system 102 can cause the second screen device to replace the first control layout with the second control layout. For example, the control layout system 102 can provide the second control layout to the second screen device 120 along with instructions to remove the first control layout from the display of the second screen device 120 and render a display of the second control layout.

As discussed above, the control layout system 102 generates adaptive control layouts during game play in response to detecting trigger events associated with the video game. FIG. 3 illustrates additional detail for the sequence of steps taken by the control layout system 102 during this process. For example, at step 302 the control layout system 102 can initiate a selected video game. For example, the control layout system 102 can provide access to a repository of digital video games stored by the digital content system 104. The control layout system 102 and/or the digital content system 104 can generate a display via the first screen device 118 including selectable options associated with some or all of the digital video game titles. In response to a detected selection of a digital video game title, the control layout system 102 can initiate the associated video game for play via the first screen device 118 by providing game data 306 (e.g., game graphics, game audio, and other game data).

Additionally, as part of initiating the selected video game (e.g., the video game 103 as shown in FIG. 1), the control layout system 102 can convert the second screen device 120 to a video game controller. For example, the control layout system 102 can convert the second screen device 120 to a video game controller by replacing a current display (e.g., a digital content system display) on the second screen device 120 with a first control layout associated with the selected video game. To illustrate, the control layout system 102 can identify a first control layout 304 as part of the initiation instructions associated with the digital video game. The first control layout 304 may be dictated by the video game (i.e., by programming created by developers of the video game) in concert with the control layout system 102 in response to an opening display or menu included in the video game. The control layout system 102 can identify or generate the first control layout 304 including one or more controls (e.g., buttons, joysticks, track pads, keyboards) at specified sizes and display locations relative to a display screen of the second screen device 120. It follows that the second screen device 120 can display the first control layout 304 at step 310, while the first screen device 118 displays the game data 306 (e.g., including game graphics) at step 308.

Following initiation of the selected video game, the second screen device 120 can detect game play at step 316. The second screen device 120 can detect control inputs 318 associated with detected interactions with the first control layout 304. To illustrate, the second screen device 120 can detect control inputs 318 including, but not limited to, one or more of tap touch gesture inputs relative to one or more controls within the first control layout 304, press-and-hold touch gesture inputs relative to one or more controls within the first control layout 304, press-and-slide touch gesture inputs relative to one or more controls within the first control layout 304, multi-finger touch gesture inputs relative to one or more controls within the first control layout 304, variable pressure touch gesture inputs relative to one or more controls within the first control layout 304, sound inputs captured by the second screen device 120, and/or gyroscopic inputs detected by the second screen device 120. The second screen device 120 can report the control inputs 318 to the control layout system 102 (e.g., via the digital content system application 116). During ongoing game play, the control layout system 102 can continually receive the control inputs 318.

As further shown in FIG. 3, at step 320 the control layout system 102 can detect a first trigger event from the received data. For example, the control layout system 102 can analyze the received data including the game play data 314 and/or the control inputs 318 to determine the type of trigger event that has occurred. To illustrate, the control layout system 102 can determine that a sequence of control inputs in connection with a particular point on a particular level of the video game means that the context of the video game is changing and this context change can be indicative of what type of trigger event has occurred. For example, the type of trigger event may be a change from game graphics to a menu (either a video game menu or a digital content system menu), a change from one level of game play to another level of game play, a change in characters being interacted with in the video game, a selection of an object or character within the game, a change in user preferences associated with the video game, a change in accessibility options associated with the game, and so forth.

In additional implementations, the control layout system 102 can detect a first trigger event as step 320 by detecting a particular interaction with the first control layout. For example, in some implementations, the first control layout may include one or more video game controls whose functionality includes causing a control layout change. To illustrate, the first control layout may include a button control that depicts a handheld radio. In response to a detected selection of that button, the control layout system 102 can detect a trigger event and generate a second control layout that mimics the look and/or functionality of a handheld radio.

In response to determining that a trigger event has occurred based on the control inputs 318, the control layout system 102 can determine whether the type of trigger event necessitates a change in control layout. For example, some types of trigger events—such as changing from one level of game play to another level of game play—may not necessitate a change in control layout because the same controls within the current control layout may be used in the new level of game play. Other types of trigger events—such as encountering a video game character or item that can only be interacted with in a specific way—may necessitate a change in control layout because the controls in the current control layout may not enable the specific interaction required by the video game character or item.

The control layout system 102 can then generate a second control layout at step 322. For example, the control layout system 102 can generate the second control layout in various ways. In one implementation, the control layout system 102 can generate the second control layout based on instructions from the video game. For example, the video game may include programming that instructs how a control layout should be generated and which video game controls should be included in the control layout for a particular type of trigger event. To illustrate, the control layout system 102 can determine that the instructions dictate specific video game controls, along with their sizes and placement locations. As such, the control layout system 102 can assemble the specific video game controls into the second control layout 324 according to these instructions.

In an additional implementation, the control layout system 102 can generate the second control layout 324 based on instructions from the digital content system 104. For example, in response to determining that the trigger event is in connection with the digital content system 104 (e.g., a change from the video game display to a digital content system menu), the control layout system 102 can query the digital content system 104 for instructions on generating the second control layout 324. In an additional implementation, the control layout system 102 can generate the second control layout 324 based on a machine learning model or other computational model. For example, the control layout system 102 can utilize a machine learning model that has been trained to generate control layout predictions based on various types of trigger events within the video game. In that implementation, the control layout system 102 can generate the second control layout 324 based on the generated control layout prediction for the determined trigger event.

The control layout system 102 can then send the second control layout 324 (or instructions regarding the same) to the second screen device 120. For example, the control layout system 102 can send the second control layout 324 for display on the second screen device 120 and/or instructions for the second screen device 120 to replace the first control layout 304 with the second control layout 324 at step 326. In additional implementations, the control layout system 102 can send these instructions along with additional instructions for the type, size, and placement of controls within the second control layout 324. In that implementation, the second screen device 120 can assemble the second control layout 324 and replace the first control layout 304 with the newly assembled second control layout 324.

In one or more implementations, the control layout system 102 can generate and display any number of control layouts during continued game play via the first screen device 118 and the second screen device 120. For example, the control layout system 102 can continue to receive additional control inputs 330 in response to the second screen device 120 detecting continued game play at step 328.

As with the step 320 above, the control layout system 102 can detect a second trigger event at step 336. The control layout system 102 can then generate additional control layouts and/or instructions. For example, at step 338, the control layout system 102 can generate the first control layout 304 in response to determining that the trigger event is a change in context to a previous context or state. To illustrate, the player may have concluded an interaction with a character in the video game that necessitated replacing the first control layout with the second control layout in step 326. In response to determining that the type of trigger event is resuming normal game play following the character encounter, the control layout system 102 can generate the first control layout 304 in the step 338 including instructions for the second screen device 120 to replace the second control layout 324 with the first control layout 304 at step 342.

At this point, as further shown in FIG. 3, the control layout system 102 can continue to receive additional control inputs 346 in response to the second screen device 120 detecting additional game play at step 344. The control layout system 102 may continue receiving the additional control inputs 346 until the video game is paused, exited, or closed via the digital content system 104.

As discussed above, the control layout system 102 can generate any number of control layouts and cause the same to be displayed by the second screen device 120. FIGS. 4A and 4B illustrate control layouts generated by the control layout system 102 and displayed on the second screen device 120. For example, as shown in FIG. 4A, the control layout system 102 can cause a first control layout 402a to be displayed by the second screen device 120. The control layout system 102 can generate the first control layout 402a including video game controls 404a, 404b, 404c, 404d, and 404e. To illustrate, the video game control 404a may include a joystick control that responds to press-and-slide touch gesture inputs that enable a player to move a character in any direction within three hundred and sixty degrees. The video game controls 404b, 404c, 404d, and 404e may respond to tap touch gesture inputs and/or press-and-hold touch gesture inputs that may have variable pressure responses. Each of the video game controls 404b-404e may be mapped to different functionality within the video game (e.g., being displayed by the first screen device 118). For example, the video game control 404b may be mapped to a punch action performed by a character within the video game in response to a detected tap touch gesture in connection with the video game control 404b. In one or more implementations, the control layout system 102 can generate the first control layout 402a such that combinations of the video game controls 404a-404e may be selected simultaneously (e.g., such that the player can cause their video game character to punch while running forward).

In response to detecting a trigger event associated with the video game, the control layout system 102 can generate a second control layout 402b, as shown in FIG. 4B. For example, based on the type of trigger event determined based on control inputs and other game data received by the control layout system 102, the control layout system 102 can generate the second control layout 402b including video game controls 404f, 404g, and 404h. As discussed above, the control layout system 102 can generate the second control layout 402b based on programming within the video game, based on instructions from the digital content system 104, based on a request from a user, and/or based on predictions from a machine learning model or other computational model. The control layout system 102 can send the second control layout 402b to the second screen device 120 and cause the second screen device 120 to display the second control layout 402b. As discussed above, the control layout system 102 can cause the second screen device 120 to replace the first control layout 402a with the second control layout 402b during game play with no interruption in the game play experience of the player.

As mentioned above, in some implementations, the control layout system 102 can generate a control layout based on instructions from the digital content system 104. For example, in response to a detected selection of a menu button 406, the control layout system 102 can determine that a system-based trigger event has occurred. In one or more implementations, the control layout system can then generate a new control layout including controls associated with a digital content system menu.

In one or more implementations, the control layout system 102 can generate control layouts including standard video game controls such as those shown in the first control layout 402a and the second control layout 402b in FIGS. 4A and 4B. In additional implementations, the control layout system 102 can generate customized video game controls that are tailored to specific game play within a specific video game. For example, as shown in FIG. 4C, the control layout system 102 can generate a control layout 402c including customized video game controls 404i, 404j, 404k, and 404l. In at least one implementation, the control layout system 102 can generate the customized video game controls 404i-404l including semantic symbols (e.g., a sword, a shield) that indicate the function of the control to the player.

To illustrate, the control layout system 102 can generate the customized video game controls 404i-404l in response to instructions from the video game programming and/or predictions from a machine learning model. Moreover, the control layout system 102 can generate the customized video game controls 404i-404l in response to determining a functionality that is mapped to each video game control. For example, in response to determining that—when selected—the video game control 404k causes the player's character to execute a sword attack, the control layout system 102 can generate the customized video game control 404k including a sword icon. In one or more implementations, the control layout system 102 can generate the customized video game controls 404i-404l such that no two video game controls depict the same semantic symbol. The control layout system 102 can further generate a control layout including some standard controls (e.g., “A,” “B”, “Select”), and some customized controls depicting semantic symbols.

In at least one implementation, the control layout system 102 can further generate customized video game controls that represent gameplay elements. For example, in a video game that includes playing cards, the control layout system 102 can generate customized video game controls that depict playing cards that may be manipulated like real playing cards. In other examples, if a video game allows for a player to build and utilize an inventory (e.g., of food, potions, weapons), the control layout system 102 can generate customized video game controls mapped to those inventory items such that the player may select or rearrange those inventory items. In another example, the control layout system 102 can generate customized video game controls that depict an interactive map, or a mini-game that must be completed on the second screen device 120.

As mentioned above, and as shown in FIG. 5, the control layout system 102 performs various functions in connection with detecting trigger events during video game play and—in response—generating an adaptive video game control layout for use on a second screen device that is physically separate from a first screen device where the video game graphics are displayed. FIG. 5 is a block diagram 500 of the control layout system 102 operating within the memory 106 of the server(s) 112 while performing these functions. As such, FIG. 5 provides additional detail with regard to these functions. For example, as shown in FIG. 5, the control layout system 102 can include a communication manager 502, a trigger event manager 504, a control layout manager 506, and a digital video game manager 508. As further shown in FIG. 5, the additional items 108 can store and maintain digital video game data 510.

In certain implementations, the control layout system 102 may represent one or more software applications, modules, or programs that, when executed by a computing device, may cause the computing device to perform one or more tasks. For example, and as will be described in greater detail below, one or more of the communication manager 502, the trigger event manager 504, the control layout manager 506, or the digital video game manager 508 may represent software stored and configured to run on one or more computing devices, such as the server(s) 112. One or more of the communication manager 502, the trigger event manager 504, the control layout manager 506, and the digital video game manager 508 of the control layout system 102 shown in FIG. 5 may also represent all or portions of one or more special purpose computers to perform one or more tasks.

As mentioned above, and as shown in FIG. 5, the control layout system 102 can include the communication manager 502. In one or more implementations, the communication manager 502 can receive game data from one or more first screen devices and/or one or more second screen devices. For example, as discussed above with regard to FIG. 3, the communication manager 502 can receive and/or detect game play data such as a current video game level being played, objects currently displayed during game play, characters currently being encountered, a video game score, and so forth.

The communication manager 502 can further receive and/or detect control inputs from a second screen device. For example, the communication manager 502 can receive and/or detect tap touch gesture inputs, press-and-hold touch gesture inputs, press-and-slide touch gesture inputs, multi-finger touch gesture inputs, variable pressure touch gesture inputs, sound inputs, or gyroscopic inputs. In one or more implementations, the communication manager 502 can receive and/or detect such control inputs relative to specific video game controls within a control layout currently displayed by a second screen device. Additionally, the communication manager 502 can receive and/or detect timing information associated with the control inputs that indicates how quickly video game controls are selected, a sequence in which video game controls are selected, and so forth.

In one or more implementations, the communication manager 502 can send, transmit, or provide control layouts to second screen devices. For example, the communication manager 502 can send a generated control layout to a second screen device. In additional implementations, the communication manager 502 can send or transmit instructions that cause the second screen device to display the control layout. For example, the communication manager 502 can send instructions that cause the second screen device to identify specific video game controls and assemble the specific video game controls into a particular layout.

As mentioned above, and as shown in FIG. 5, control layout system 102 can include the trigger event manager 504. In one or more implementations, the trigger event manager 504 can analyze video game play data and/or inputs from the second screen device to determine whether a trigger event has occurred. For example, the trigger event manager 504 can determine that a particular character, item, level, etc. has occurred within a video game and/or that a particular sequence of control inputs indicates that a trigger event has occurred. Additionally, the trigger event manager 504 can analyze the control inputs in view of the game play data associated with the video game 103. For example, the trigger event manager 504 can determine that one or more control inputs at a particular point or level within the video game 103 (e.g., indicated by the game play data) indicates that a trigger event has occurred. The trigger event manager 504 can perform this analysis in connection with one or more of decision trees, point clouds, databases, video game specified rules, and/or machine learning models. As discussed above, the trigger event manager 504 can further determine that a trigger event has occurred in response to detecting a specific type of interaction with one or more video game controls within a control layout currently displayed by the second screen device 120.

In response to determining that a trigger event has occurred, the trigger event manager 504 can determine what type of trigger event has occurred. For example, the trigger event manager 504 can determine the type of trigger event by analyzing the control inputs and/or the game play data in more detail. For instance, the trigger event manager 504 can determine a specific change occurring in the video game 103 and the one or more control inputs associated with that specific change. To illustrate, the trigger event manager 504 can analyze the game play data to determine that a specific character has been encountered within the video game 103. By further detecting a sequence of control inputs indicating that the player's character has approached the specific character, the trigger event manager 504 can determine that the type of trigger event is a special character encounter.

In some implementations, the trigger event manager 504 can determine the type of trigger event based on the programming of the video game 103. For example, the video game 103 can specify that if a player moves to a new level within the video game 103 that a new level type of trigger event has occurred. In some implementations, the trigger event manager 504 can determine the type of trigger event in response to input from the digital content system 104. For example, the control layout system 102 can notify the digital content system 104 when a control input indicates access to a digital content system menu. The digital content system 104 may then instruct the control layout system 102 that a system menu access type of trigger event has occurred.

In at least one implementation, the trigger event manager 504 can utilize various artificial intelligence techniques to determine the type of trigger event that has occurred. For example, the trigger event manager 504 can generate a machine learning model input based on the received game play data and control inputs. The trigger event manager 504 can further apply a machine learning model to the generated input to generate a trigger event type prediction. For example, the trigger event manager 504 can train the machine learning model to generate trigger event type predictions by applying the machine learning model to training inputs, and then back-propagating generated training predictions over multiple training cycles until the accuracy of the training predictions converges.

The trigger event manager 504 can further determine whether the determined type of trigger event necessitates a control layout change. For example, the trigger event manager 504 can access video game programming data that dictates which types of trigger events necessitate control layout changes. In additional implementations, the trigger event manager 504 can further train the machine learning model described above to generate trigger event type predictions that further indicate whether the predicted trigger event type necessitates a control layout change.

As mentioned above, and as shown in FIG. 5, the control layout system 102 can include the control layout manager 506. In one or more implementations, the control layout manager 506 can generate control layouts when a type of trigger event necessitates a control layout change. For example, the control layout manager 506 can generate a control layout by determining video game controls associated with the type of trigger event and assembling the video game controls into a layout. In some implementations, the control layout manager 506 can access video game programming that dictates a specific layout of video game controls associated with a type of trigger event. In additional implementations, the control layout manager 506 can further train the machine learning model to predict a control layout necessitated by a predicted type of trigger event.

The control layout manager 506 can generate a control layout including specific video game controls at specific sizes and at specific locations within the control layout. For example, the control layout manager 506 can generate the control layout along with instructions for how the second screen device can display the control layout. In another implementation, the control layout manager 506 can generate the control layout as a set of instructions that dictate how the second screen device can generate and display the determined control layout.

In at least one implementation, the control layout manager 506 can further generate customized video game controls that include semantic symbols. For example, in response to determining that a video game control within a control layout is mapped to a specific function within the video game 103, the control layout manager 506 can customize the video game control with a semantic symbol that represents the specific function. In this way, the control layout manager 506 can further tailor video game controls within a control layout to enhance video game play.

As mentioned above, and as shown in FIG. 5, the control layout system 102 can include the digital video game manager 508. In one or more implementations, the digital video game manager 508 can load or initiate a selected video game. For example, the digital video game manager 508 can cause a first screen device to render video game graphics. Additionally, the digital video game manager 508 can cause a second screen device to display an initial video game control layout.

For example, the digital video game manager 508 can convert the second screen device into a video game controller as part of initiating the selected video game. For example, the digital video game manager 508 can replace a current display on the second screen device with an initial video game control layout.

As shown in FIGS. 1 and 5, the server(s) 112 and the digital content receiver 114 can include one or more physical processors, such as the physical processor 110. The physical processor 110 can generally represent any type or form of hardware-implemented processing unit capable of interpreting and/or executing computer-readable instructions. In one implementation, the physical processor 110 may access and/or modify one or more of the components of the control layout system 102. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Additionally, the server(s) 112 and the digital content receiver 114 can include the memory 106. In one or more implementations, the memory 106 generally represents any type or form of volatile or non-volatile storage device or medium capable of storing data and/or computer-readable instructions. In one example, the memory 106 may store, load, and/or maintain one or more of the components of the control layout system 102. Examples of the memory 106 can include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Moreover, as shown in FIG. 5, the server(s) 112 and the digital content receiver 114 can include the additional items 108. On the server(s) 112, the additional items 108 can include the digital video game data 510. In one or more implementations, the digital video game data 510 can include digital video games. The digital video game data 510 can further include machine learning models for specific digital video games that predict whether a trigger event has occurred, a type of trigger event that has occurred, whether the type of trigger event necessitates a control layout change, and/or video game controls that should be included in a new control layout based on the type of trigger event. In some implementations, the digital video game data 510 can also include algorithms, tables, databases, decision trees, point clouds, etc. for use in determining whether a trigger event has occurred, determining a type of trigger event that has occurred, determining whether the type of trigger event necessitates a control layout change, and/or determining video game controls that should be included in a new control layout based on the type of trigger event.

In summary, the control layout system 102 can seamlessly generate and provide adaptive control layouts that are tailored to specific trigger events associated with video game play. For example, as discussed above, the control layout system 102 can determine whether a type of trigger event necessitates a control layout change on a second screen device that is physically separate from a first screen device where video game graphics are displayed. The control layout system 102 can further generate a new control layout that can include standard video game controls and/or customized video game controls. In one or more implementations, the control layout system 102 can provide the new control layout to the second screen device in a way that does not interrupt game play, but rather enriches the game play experience.

### EXAMPLE EMBODIMENTS

Example 1: A computer-implemented method for generating adaptive control layouts for a second screen device while a video game is being played. For example, the method may include, in response to a detected selection of a video game via a first screen device, converting a second screen device to a game controller with a first control layout, receiving, from the second screen device and via the first control layout, one or more control inputs associated with the video game displayed on the first screen device, detecting a trigger event associated with the video game that necessitates a second control layout for the second screen device, and causing the second screen device to replace the first control layout with the second control layout.
Example 2: The computer-implemented method of Example 1, wherein the first screen device is physically separate from the second screen device.
Example 3: The computer-implemented method of any of Examples 1 and 2, wherein receiving, from the second screen device and via the first control layout, the one or more control inputs associated with the video game displayed on the first screen device includes receiving one or more of tap touch gesture inputs, press-and-hold touch gesture inputs, press-and-slide touch gesture inputs, multi-finger touch gesture inputs, variable pressure touch gesture inputs, sound inputs, or gyroscopic inputs.
Example 4: The computer-implemented method of any of Examples 1-3, wherein detecting the trigger event associated with the video game that necessitates the second control layout for the second screen device includes determining a type associated with the trigger event and determining that the type of trigger event necessitates a control layout that is different from the first control layout.
Example 5: The computer-implemented method of any of Examples 1-4, wherein detecting the trigger event associated with the video game that necessitates the second control layout for the second screen device includes detecting at least one of a predetermined point in the video game, a predetermined level in the video game, a predetermined character in the video game, a predetermined object in the video game, a preference request associated with a user of the second screen device, or an accessibility selection received via the first control layout.
Example 6: The computer-implemented method of any of Examples 1-5, wherein detecting the trigger event associated with the video game that necessitates the second control layout for the second screen device includes detecting an interaction with a specific video game control within the first control layout.
Example 7: The computer-implemented method of any of Examples 1-6, further including, in response to detecting the trigger event, generating the second control layout for the second screen device based on the trigger event.
Example 8: The computer-implemented method of any of Examples 1-7, wherein generating the second control layout for the second screen device based on the trigger event includes determining, based on the video game, one or more video game controls correlated with the trigger event and assembling the one or more video game controls into the second control layout.
Example 9: The computer-implemented method of any of Examples 1-8, wherein causing the second screen device to replace the first control layout with the second control layout includes generating display instructions including instructions for removing the first control layout from the second screen device and instruction for displaying the one or more video game controls in the second control layout and providing the display instructions to the second screen device.
Example 10: The computer-implemented method of any of Examples 1-9, further including receiving, during ongoing game play of the video game and via the second control layout on the second screen device, additional control inputs associated with the video game displayed on the first screen device, detecting an additional trigger even associated with the video game that necessitates the first control layout for the second screen device, and causing the second screen device to replace the second control layout with the first control layout.

In some examples, a system may include at least one processor and a physical memory including computer-executable instructions that, when executed by the at least one processor, cause the at least one processor to perform various acts. For example, the computer-executable instructions may cause the at least one processor to perform acts including, in response to a detected selection of a video game via a first screen device, converting a second screen device to a game controller with a first control layout, receiving, from the second screen device and via the first control layout, one or more control inputs associated with the video game displayed on the first screen device, detecting a trigger event associated with the video game that necessitates a second control layout for the second screen device, and causing the second screen device to replace the first control layout with the second control layout.

Additionally in some examples, a non-transitory computer-readable medium can include one or more computer-executable instructions that, when executed by at least one processor of a computing device, cause the computing device to perform various acts. For example, the one or more computer-executable instructions may cause the computing device to, in response to a detected selection of a video game via a first screen device, convert a second screen device to a game controller with a first control layout, receive, from the second screen device and via the first control layout, one or more control inputs associated with the video game displayed on the first screen device, detect a trigger event associated with the video game that necessitates a second control layout for the second screen device, and cause the second screen device to replace the first control layout with the second control layout.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of,” Finally, for ease of use, the terms “including” and “having” (and their derivatives), as used in the specification and claims, are interchangeable with and have the same meaning as the word “comprising.”

What is claimed is:

1. A computer-implemented method comprising:
in response to a detected selection of a video game via a first screen device, converting a second screen device to a game controller with a first control layout;
receiving, from the second screen device and via the first control layout, one or more control inputs associated with the video game displayed on the first screen device;
detecting a trigger event associated with the video game that necessitates a second control layout for the second screen device; and
causing the second screen device to replace the first control layout with the second control layout.

2. The computer-implemented method of claim 1, wherein the first screen device is physically separate from the second screen device.

3. The computer-implemented method of claim 1, wherein receiving, from the second screen device and via the first control layout, the one or more control inputs associated with the video game displayed on the first screen device comprises receiving one or more of tap touch gesture inputs, press-and-hold touch gesture inputs, press-and-slide touch gesture inputs, multi-finger touch gesture inputs, variable pressure touch gesture inputs, sound inputs, or gyroscopic inputs.

4. The computer-implemented method of claim 1, wherein detecting the trigger event associated with the video game that necessitates the second control layout for the second screen device comprises:
determining a type associated with the trigger event; and
determining that the type of trigger event necessitates a control layout that is different from the first control layout.

5. The computer-implemented method of claim 1, wherein detecting the trigger event associated with the video game that necessitates the second control layout for the second screen device comprises detecting at least one of: a predetermined point in the video game, a predetermined level in the video game, a predetermined character in the video game, a predetermined object in the video game, a preference request associated with a user of the second screen device, or an accessibility selection received via the first control layout.

6. The computer-implemented method of claim 1, wherein detecting the trigger event associated with the video game that necessitates the second control layout for the second screen device comprises detecting an interaction with a specific video game control within the first control layout.

7. The computer-implemented method of claim 1, further comprising, in response to detecting the trigger event, generating the second control layout for the second screen device based on the trigger event.

8. The computer-implemented method of claim 7, wherein generating the second control layout for the second screen device based on the trigger event comprises:
determining, based on the video game, one or more video game controls correlated with the trigger event; and
assembling the one or more video game controls into the second control layout.

9. The computer-implemented method of claim 8, wherein causing the second screen device to replace the first control layout with the second control layout comprises:
generating display instructions comprising instructions for removing the first control layout from the second screen device and instructions for displaying the one or more video game controls in the second control layout; and
providing the display instructions to the second screen device.

10. The computer-implemented method of claim 1, further comprising:
receiving, during ongoing game play of the video game and via the second control layout on the second screen device, additional control inputs associated with the video game displayed on the first screen device;
detecting an additional trigger event associated with the video game that necessitates the first control layout for the second screen device; and
causing the second screen device to replace the second control layout with the first control layout.

11. A system comprising:
at least one physical processor; and
physical memory comprising computer-executable instructions that, when executed by the at least one physical processor, cause the at least one physical processor to perform acts comprising:
in response to a detected selection of a video game via a first screen device, converting a second screen device to a game controller with a first control layout;
receiving, from the second screen device and via the first control layout, one or more control inputs associated with the video game displayed on the first screen device;
detecting a trigger event associated with the video game that necessitates a second control layout for the second screen device; and
causing the second screen device to replace the first control layout with the second control layout.

12. The system of claim 11, wherein the first screen device is physically separate from the second screen device.

13. The system of claim 11, wherein receiving, from the second screen device and via the first control layout, the one or more control inputs associated with the video game displayed on the first screen device comprises receiving one or more of tap touch gesture inputs, press-and-hold touch gesture inputs, press-and-slide touch gesture inputs, multi-finger touch gesture inputs, variable pressure touch gesture inputs, sound inputs, or gyroscopic inputs.

14. The system of claim 11, wherein detecting the trigger event associated with the video game that necessitates the second control layout for the second screen device comprises:
determining a type associated with the trigger event; and
determining that the type of trigger event necessitates a control layout that is different from the first control layout.

15. The system of claim 11, wherein detecting the trigger event associated with the video game that necessitates the second control layout for the second screen device comprises detecting at least one of: a predetermined point in the video game, a predetermined level in the video game, a predetermined character in the video game, a predetermined object in the video game, a preference request associated with a user of the second screen device, an accessibility selection received via the first control layout, or an interaction with a specific video game control within the first control layout.

16. The system of claim 11, further comprising computer-executable instructions that, when executed by the at least one physical processor, cause the at least one physical processor to perform an act comprising, in response to detecting the trigger event, generating the second control layout for the second screen device based on the trigger event.

17. The system of claim 16, wherein generating the second control layout for the second screen device based on the trigger event comprises:
determining, based on the video game, one or more video game controls correlated with the trigger event; and
assembling the one or more video game controls into the second control layout.

18. The system of claim 17, wherein causing the second screen device to replace the first control layout with the second control layout comprises:
generating display instructions comprising instructions for removing the first control layout from the second screen device and instructions for displaying the one or more video game controls in the second control layout; and
providing the display instructions to the second screen device.

19. The system of claim 11, further comprising computer-executable instructions that, when executed by the at least one physical processor, cause the at least one physical processor to perform acts comprising:
receiving, during ongoing game play of the video game and via the second control layout on the second screen device, additional control inputs associated with the video game displayed on the first screen device;
detecting an additional trigger event associated with the video game that necessitates the first control layout for the second screen device; and
causing the second screen device to replace the second control layout with the first control layout.

20. A non-transitory computer-readable medium comprising one or more computer-executable instructions that, when executed by at least one processor of a computing device, cause the computing device to:
in response to a detected selection of a video game via a first screen device, convert a second screen device to a game controller with a first control layout;
receive, from the second screen device and via the first control layout, one or more control inputs associated with the video game displayed on the first screen device;
detect a trigger event associated with the video game that necessitates a second control layout for the second screen device; and
cause the second screen device to replace the first control layout with the second control layout.
